(19) United States
(12) Patent Application Publication
(10) Pub. No.: US 2004/0051672 A1
(43) Pub. Date: Mar. 18, 2004

(54) Mobile telephone comprising a multi-band antenna

(76) Inventors: Peter Nevermann, San Diego, CA (US); Sheng-Gen Pan, Kamp-Lintfort (DE)

Correspondence Address: BELL, BOYD & LLOYD, LLC, P. O. BOX 1135, CHICAGO, IL, 60690-1135, US

(21) Appl. No.: 10/398,665

(22) PCT Filed: Oct. 5, 2001
(86) PCT No.: PCT/DE01/03832

(30) Foreign Application Priority Data
Oct. 5, 2000 (DE) 100494102

(51) Int. Cl. H01Q 1/24; H01Q 1/36

(52) U.S. Cl. 343/702; 343/895

(57) ABSTRACT

An antenna means for a portable radio communication device, in particular a hand-portable mobile telephone, having at least one radiating element that has a meandering and cylindrical configuration. This structure is specifically advantageous in combination with an extendable and retractable whip antenna and, when having two or more meandering radiating elements, in multi-band radiating structures. The antenna device is suitable for manufacturing in large quantities, for example by a flexible printed circuit board technique.

The present invention relates to a mobile radiotelephone comprising a multi-band antenna which has a meandering conductor structure and a contact spring for contacting the conductor structure to a transmitting-receiving electronics device.

A mobile radiotelephone of this type can be implemented as a mobile telephone, for example. The dimensions of the antenna of such a device, which antenna is nowadays integrated into the housing on a wide scale, are restricted for reasons of design. Furthermore, this mobile radiotelephone should also be increasingly capable of operating not only in a single network, corresponding to a single frequency range, but also in a plurality of networks, corresponding to a plurality of frequency ranges. An (integrated) antenna is therefore required which is capable of being used in two or more frequency ranges. In addition, there is a requirement that the mobile radiotelephone in question should be able to be implemented as cost-effectively as possible in respect of its performance capabilities and its design.

The multi-band antenna integrated into the housing of known mobile radiotelephones consists, for example, of a plurality of partial antennas. With regard to these partial antennas, these are either cylindrically symmetric helical wire structures or planar antennas which are preferably implemented on circuit boards. However, since their basic forms do not correspond to the shape of the housing which typically has a generally elliptical cross-section, such antennas require a relatively high amount of space in the housing. For this reason, the requirements relating to the design of the mobile radiotelephone cannot be complied with or can only be complied with inadequately, given the small dimensions.

A method is known from WO 99/22420 for implementing the multi-band antenna of the mobile radiotelephone in question by means of the application of meandering structures onto flexible printed circuit board material. A multi-band antenna of this type exhibits great flexibility as a result. The costs for the flexible base material and the requisite contacting to the flexible conductor material do however result in the fact that the costs for this antenna correspond to a multiple of the costs of the aforementioned nonflexible antenna.

One object of the present invention consists in creating a mobile radiotelephone of the type mentioned at the beginning whose multi-band antenna can be manufactured cost-effectively and guarantees freedom on the choice of design for the mobile radiotelephone. The object of the invention is achieved by the features described in claim 1. Advantageous developments of the invention are set down in the subclaims.

Since the meandering conductor structure and the contact spring of the antenna are formed according to the invention as a single part which is non-overlapping in its development, this antenna can be manufactured without any difficulties and cost-effectively by means of a single punching operation, which is then followed simply by an additional bending operation, if necessary. Since the single-piece punched and bent part according to the invention can be shaped as desired within broad limits, it can be adapted without any difficulties to the desired design of the mobile radiotelephone without attention needing to be paid to the structure of the antenna.

A further advantage of the antenna according to the invention consists in the fact that it can be produced with a high speed of manufacture and therefore with low manufacturing costs because it is possible to revert to using the standard punch and bend method. Since the multi-band antenna is designed as a single-piece punched and bent part, there is no need for separate manufacture and provision of the antenna spring.

By preference, the two meandering structures, of which there are at least two, of the multi-band antenna formed as a single-piece punched and bent part are connected in parallel and arranged so close to one another that a clear coupling is achieved, with the result that the overall volume of the multi-band antenna is kept to a minimum. In this situation, usage of the distributed partial inductances and capacitances of the meanders is optimized with the result that the antenna can be operated reliably in a plurality of frequency ranges. By means of optimization it is possible to deploy the multi-band antenna for example in the vicinity of its first resonant frequency for one of the target frequency bands, GSM for example, while close to its second resonant frequency it functions in such a broadband manner that this allows an application in the case of two further frequency bands, PCN and PCS for example.

A further advantage of the multi-band antenna formed as a single-piece punched and bent part consists in the fact that a rated impedance of 50 Ohm can be implemented without any difficulties, with the result that this antenna can be operated without an additional adapter network which is required on the basis of the prior art. This ensures that the antenna formed according to the invention can be operated without suffering those losses which are unavoidable as a result of adapter elements on the basis of the prior art.

The invention will be described in the following with reference to the drawings by way of example. In the drawings:

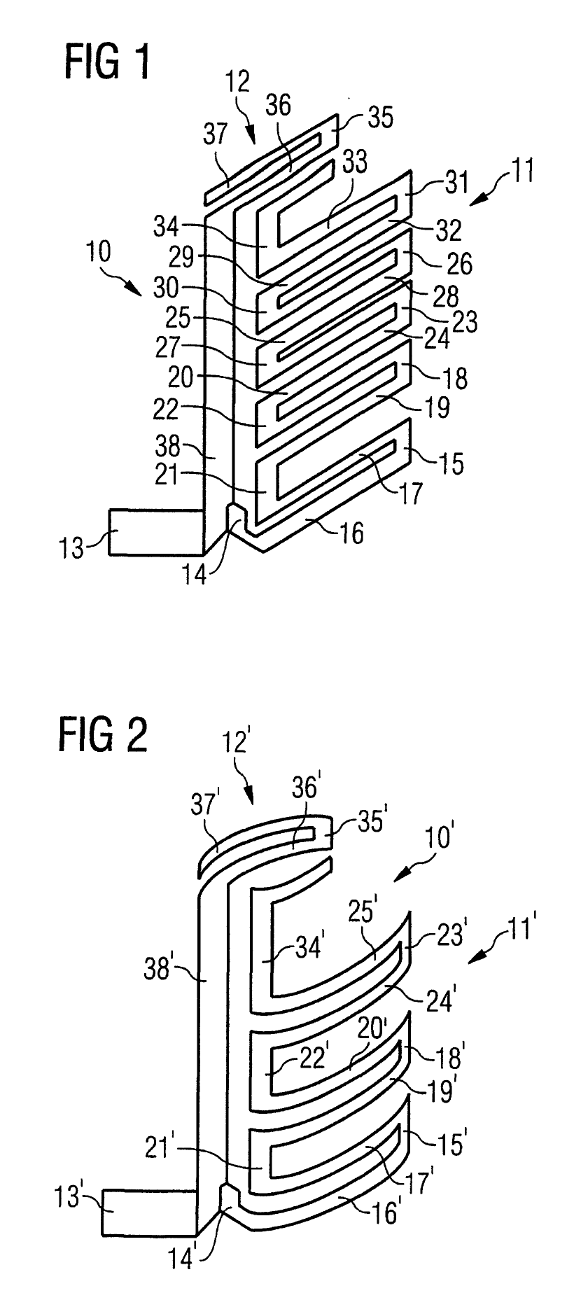

FIG. 1 shows an embodiment of a multi-band antenna of the mobile radiotelephone according to the invention in side elevation view,

FIG. 2 shows a second embodiment of a multi-band antenna of the mobile radiotelephone according to the invention in side elevation view, and

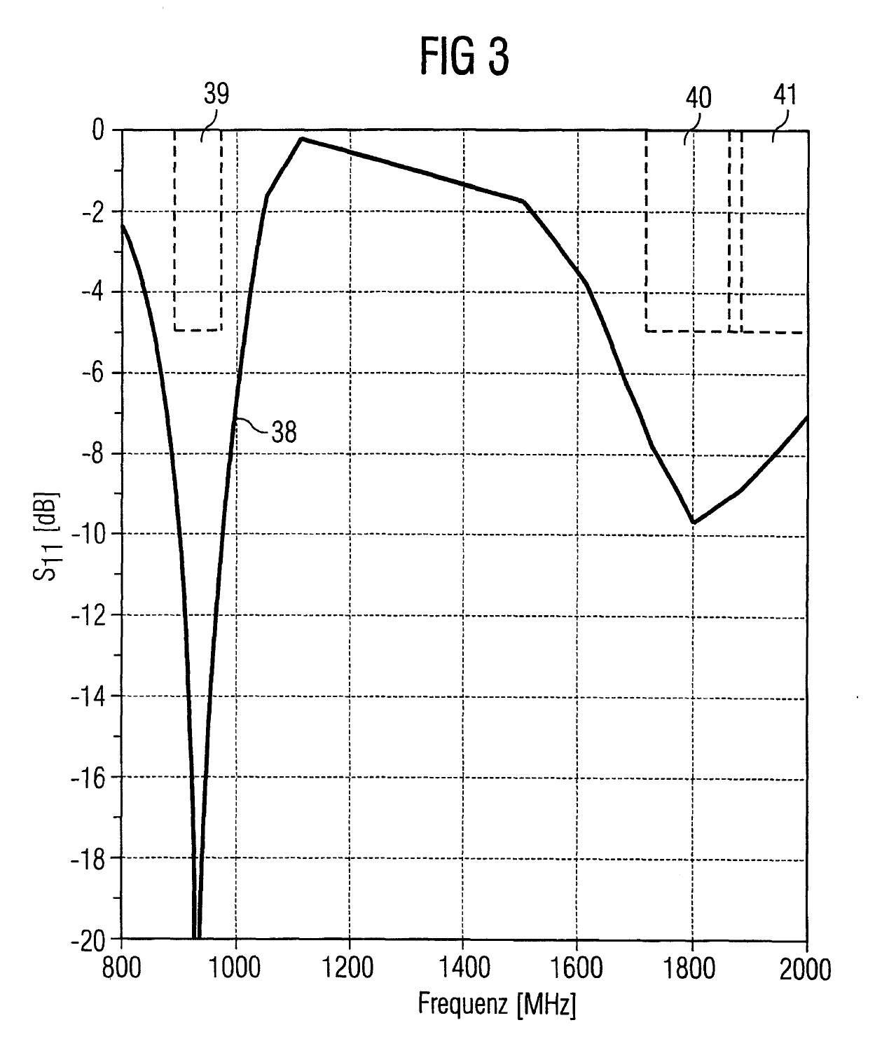

FIG. 3 shows in diagrammatic form the reflection coefficient of the multi-band antenna shown in FIG. 1, whereby the frequency bands covered by the antenna are shown entered in dashed lines.

In FIG. 1, a multi-band antenna is denoted generally by the reference number 10. With regard to the multi-band antenna 10, this is a single-piece punched and bent part comprising a meandering conductor structure with a first meander 11 and a second meander 12 and a contact spring 13. The two meanders 11, 12 and the contact spring 13 are located relative to one another in such a way that there is no overlap in their development (in a developed state). The development of the first meander 11 is formed in planar fashion in the same way as the second meander 12, and these two meanders are situated in two laterally displaced planes in their developed state and are connected with one another by way of a connecting piece 14 which is positioned at right angles to the meander planes. The contact spring 13 is located in the area of the connecting piece 14 and represents an extension of this connecting piece.

The first meander 11 comprises a first meander section 15, starting from the connecting piece 14, with two arms 16 and 17 running parallel to one another. The first meander section 15 is followed by a second meander section 18 which comprises two arms 19 and 20 running parallel to one another and also parallel to the arms 16, 17 of the first meander section 15. The second meander section 18 is connected to the first meander section 17 by way of a crosspiece 21. The second meander section is followed, connected by way of a crosspiece 22, by a third meander section 23 which comprises two arms 24, 25 running parallel to one another and also parallel to the aforementioned arms 16, 17 and 19, 20. The third meander section 23 is followed by a fourth meander section 26 which is connected to the preceding meander section 23 by way of a crosspiece 27 and comprises two arms 28 and 29 which run parallel to one another and also to the aforementioned arms. The fourth meander section 26 is connected by way of a crosspiece 30 to a following fifth meander section 31 which like the preceding meander sections comprises two arms 32 and 33 in parallel alignment. The fifth meander section 31 runs into a terminating arm 34 extending in the meander direction and bent inwards by 90°.

The mutual spacing of the five meander sections 15, 18, 23, 26 and 31 is chosen to be different in each case in the same way as is the relative spacing of their arms 16, 17, 19, 20, 24, 25, 28, 29 and 32, 33. These spacings and their sequence are optimized in favor of the frequency range to be covered by the antenna.

The second meander 12 has a less complex structure than the first meander 11 and comprises a single meander section 35 which comes to be located at a distance above the terminating arm 34 of the first meander section 11 and has arms 36, 37 running parallel to one another and also to the arms of the first meander 11. The meander section 35 is connected by means of its lower arm 36 by way of a further, long connecting piece 38 to the contact spring 13 and the connecting piece 14.

Three frequency ranges in total are defined as a result of the meandering conductor structure 11, 12 of the multi-band antenna 10. The pertinent reflection coefficient of the multi-band antenna 10 is shown in FIG. 3 as a solid line and generally denoted by the reference number 38. The three frequency ranges or bands of the multi-band antenna 10, corresponding to the EGSM band, the PCN band and the PCS band, are shown in dashed lines and are denoted by the reference numbers 39, 40 and 41.

FIG. 2 shows an alternative embodiment of the multi-band antenna 10 shown in FIG. 1. The multi-band antenna 10′ shown in FIG. 2 essentially has the same basic structure as the multi-band antenna 10 shown in FIG. 1 but with the difference that the development of the meanders comes to be located not in flat planes but on curved surfaces and with the difference that the first meander 11′ comprises not five but simply three meander sections. The second meander 12′ on the other hand is configured corresponding to the first meander 11. The same elements of the antenna 10′ are denoted by the same reference numbers as for the antenna 10, for which reason a detailed description of these elements is unnecessary. A further difference distinguishing the antenna 10′ from the antenna 10 is the fact that the distances between their meander sections and also the distances between the arms of the meander sections are different, with the result that a different reflection coefficient is produced for the antenna 10′ than is the case with the antenna 10.

The invention is not restricted to the two specific embodiments of a multi-band antenna described above. Rather, the invention can be embodied in any desired meander structures, including zigzag-shaped structures, as long as these structures can be implemented as a single-piece punched and bent part which is non-overlapping in its development.

1. Mobile radiotelephone comprising a multi-band antenna which has at least one meandering conductor structure (11, 12; 11′, 12′), having a first (11; 11′) and a second (12; 12′) meander, and a contact spring (13; 13′) for contacting the conductor structure (11, 12; 11′, 12′) to a transmitting-receiving electronics device, characterized in that the meandering conductor structure (11, 12, 11′, 12′) and the contact spring (13; 13′) are formed as a single-piece punched and bent part which is non-overlapping in its development, whereby the first and the second meander (11, 12) are located in two laterally displaced planes.

2. Mobile radiotelephone comprising a multi-band antenna which has at least one meandering conductor structure (11, 12; 11′, 12′), having a first (11; 11′) and a second (12; 12′) meander, and a contact spring (13; 13′) for contacting the conductor structure (11, 12; 11′, 12′) to a transmitting-receiving electronics device, characterized in that the meandering conductor structure (11, 12, 11′, 12′) and the contact spring (13; 13′) are formed as a single-piece punched and bent part which is non-overlapping in its development, whereby the first meander (11′) is located on a first curved surface and the second meander (12′) is located on a second curved surface.

3. Mobile radiotelephone according to claim 1 or 2, characterized in that the meandering conductor structure (11, 12) comprises meanders (11 and 12) of differing configuration in order to provide the multi-band functionality of the antenna.

4. Mobile radiotelephone according to one of the preceding claims, characterized in that the meanders (11 and 12) are located beside one another.

5. Mobile radiotelephone according to claim 4, characterized in that the meanders (11 and 12) comprise a different number and/or shape of meander sections (15, 18, 23, 26, 31).

6. Mobile radiotelephone according to one of claims 3 through 5, characterized in that the meanders (11 and 12) are connected to one another by way of a connecting piece (14) at an antenna signal infeed/outlet point.

7. Mobile radiotelephone comprising a triple-band antenna according to claim 6, characterized in that the second meander (12) joins up with the end of a first meander (11) furthest from the infeed/outlet point, and that a connecting piece (38) to the second meander (12) runs along a long side of the first meander (11).

8. Mobile radiotelephone comprising a triple-band antenna according to claim 7, characterized in that one of the two meanders (11 and 12) is tuned to a first resonant frequency while the other meander is tuned on a more broadband basis to a second and a third resonant frequency.

9. Mobile radiotelephone according to one of claims 1 through 8, characterized in that the meandering conductor structure (11, 12) is essentially formed in a planar fashion in its development.

10. Mobile radiotelephone according to one of claims 1 through 9, characterized in that the meandering conductor structure (11, 12) is essentially formed in a curved fashion in its development.

11. Mobile radiotelephone according to one of claims 1 through 10, characterized in that the meandering conductor structure (11, 12) has a rated impedance of 50 Ohm overall.
